(19) United States
(12) Patent Application Publication
(10) Pub. No.: US 2017/0125759 A1
(43) Pub. Date: May 4, 2017

(54) METHODS FOR PREVENTING OR CONTAINING THERMAL RUNAWAY IN A BATTERY PACK

(71) Applicant: Navitas Systems, LLC, Woodridge, IL (US)

(72) Inventors: Christopher Silkowski, Livonia, MI (US); Patrick L. Hagans, Cleveland Heights, OH (US)

(73) Assignee: NAVITAS SYSTEMS, LLC, Woodbridge, IL (US)

(21) Appl. No.: 15/315,072

(22) PCT Filed: May 29, 2015
(86) PCT No.: PCT/US15/33266

§ 371 Date: Nov. 30, 2016

Related U.S. Application Data
(60) Provisional application No. 62/005,184, filed on May 30, 2014.

(51) Int. Cl. H01M 2/12; A62C 3/16; H01M 10/42

(52) U.S. Cl. CPC H01M 2/127; H01M 10/4285; H01M 2/1235; A62C 3/16; H01M 2200/20

(57) ABSTRACT

Processes for preventing or containing a thermal runaway event in a battery cell are provided that include localizing an effective amount of a thermally decomposable flame retardant to a target site on a cell or battery, where the flame retardant is localized so as not to coat the entire cell or large portions of the cell. It was discovered that targeted localization of flame retardant material(s) improves cell safety by preventing thermal runaway under adverse operating conditions.

### CROSS REFERENCE TO RELATED APPLICATIONS

This application depends from and claims priority to U.S. Provisional Application No. 62/005,184 filed May 30, 2014, the entire contents of which are incorporated herein by reference.

### FIELD

The invention relates generally to batteries, and more particularly to secondary batteries that may be exposed to extreme conditions such as those known historically to lead to thermal runaway. The invention provides methods of preventing or containing hazardous conditions in or around a battery thereby improving safety of secondary batteries.

### BACKGROUND

Secondary batteries offer a number of significant environmental and economic benefits to the user. These rechargeable cells are capable of being repeatedly reused thereby reducing waste and the expense associated with continual replacement of primary disposable batteries. The chemistries commonly employed in secondary cells, however, are often less stable than those found in primary cells. In particular, battery chemistries used in lithium-ion cells are more prone to thermal runaway than primary cells. Thermal runaway occurs when the internal reaction rate increases to the point where more energy is being generated than is capable of being released. In a thermal runaway condition, the runaway becomes a self-sustaining feedback loop further increasing the internal reaction rate and heat generation. Heat continues to increase until combustion occurs within the cell itself and expanding to the surrounding pack and environment. These thermal runaway events can be initiated by several effectors including improper cell use, a short circuit in the cell, physical abuse such as in the case of impact or penetration by a projectile, or other exposure of the cell to extreme temperatures.

During thermal runaway, the cell temperature can reach 900° C. or more. In typical cell arrangements, this heat that can readily transfer to neighboring cells in a pack. If the temperature increase in neighboring cells remains unchecked the thermal runaway event can eventually spread to every cell in the pack. This results in immediate power loss and the risk of severe collateral damage to any device or system using the pack.

As such, there is a need for improved methods and systems for preventing or containing the events that lead to thermal runaway thereby improving cell safety.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

Provided are methods for preventing or containing a thermal runaway event in a battery cell. It was discovered that by specifically localizing a thermally decomposable flame retardant to a target site on or above a cell that thermal runaway events could be prevented or contained such that cell safety is greatly improved. The localization of the flame retardant was discovered not to require large amounts of material or coating of the entire or a majority of the cell. Thus, the methods and devices provide improved cell safety while saving significant expense and the need for excess flame retardant material.

According to one aspect is provided a process for preventing or containing a thermal runaway event in a battery cell including providing a secondary battery cell comprising a target site comprising a pressure relief feature, and localizing an effective amount of a thermally decomposable flame retardant to the target site, there the localizing is exclusive of non-target site regions surrounding the target site or within the cell. A target site is optionally external to a cell, optionally on the cell surface, above the cell surface during normal operation, or combinations thereof. A target site optionally includes a vent plug. A target site is optionally proximate to or surrounding an ignition source. Optionally, a target site is intermediate to one or more tabs and one or more electrodes. Optionally, a target site experiences a temperature of 100° C. or greater upon overcharge of greater than 200% the state of charge (SOC). A cell is optionally prismatic cell. A flame retardant is optionally capable of decomposing to form a gaseous halogen-bearing species upon reaching a temperature of 200° C. or greater. Optionally, a flame retardant is or includes a heat conductor.

In other aspects, a process for measuring thermal runaway in a secondary cell is provided wherein the process includes: localizing a thermally decomposable flame retardant to a target site of a secondary battery cell, where the localizing is exclusive of non-target site regions surrounding or within the cell; subjecting the cell to an overcharge condition; and activating an ignition source to ignite electrolyte vapor produced by the overcharge condition. Optionally, the flame retardant is localized to a screen or other porous surface suspended above said target area. Optionally, the flame retardant is localized to a pressure relief feature on the cell. Optionally, the cell is overcharged to greater than 100% SOC, optionally to greater than 200% SOC. Optionally, the process includes wrapping or otherwise containing the cell in a thermally insulating environment. A cell is optionally a prismatic cell, button cell, pouch cell, or a cylindrical cell.

In some aspects, provided is a apparatus for testing thermal runaway in a battery or battery cell, the apparatus including: a base a top plate including a passage, the top plate fixedly associated with the base by a plurality of supports or a single continuous support, the top plate associated with the base with sufficient force to hold a battery or battery cell therebetween under conditions of thermal runaway; a screen suspended at least partially above the top plate above the passage; and a chimney on the top plate above the passage. Optionally, the test apparatus is axially surrounded by an inner structure where axially is relative to the distance between the top plate and bottom plate. Optionally, the inner structure is axially surrounded by an outer structure. Optionally, a space between the inner structure and the outer structure is filled with an insulating material.

### BRIEF DESCRIPTION OF THE DRAWINGS

FIG. 1 illustrates an exemplary test apparatus according to one aspect;

FIG. 2A illustrates the barrel wall temperature of 6 Ah cells overcharged with and without FR materials and wherein FR-B insufficient mass is 16 g, FR-B sufficient mass is 63 g, FR-A sufficient mass is 69 g, RF-F sufficient mass is 72 g, and FR-A+F sufficient mass is 60 g of the mixture;

FIG. 2B illustrates barrel wall temperature of 6 Ah cells overcharged with and without FR materials and wherein FR-B insufficient mass is 16 g, FR-B sufficient mass is 63 g, FR-A sufficient mass is 69 g, RF-F sufficient mass is 72 g, and FR-A+F sufficient mass is 60 g of the mixture;

FIG. 2C illustrates cell skin temperature of 6 Ah cells overcharged with and without FR materials and wherein FR-B insufficient mass is 16 g, FR-B sufficient mass is 63 g, FR-A sufficient mass is 69 g, RF-F sufficient mass is 72 g, and FR-A+F sufficient mass is 60 g of the mixture;

FIG. 3A illustrates the vent plug end of test cells that were either sufficiently coated with FR material on the vent plug (left), insufficiently coated (center) or not coated (right) following exposure to conditions to produce thermal runaway in untreated cells; and

FIG. 3B illustrates the electrode end of the test cells of FIG. 3A that were either sufficiently coated with FR material on the vent plug (left), insufficiently coated (center) or not coated (right) following exposure to conditions to produce thermal runaway in untreated cells.

### DETAILED DESCRIPTION

The following description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Provided are methods for improving the safety of secondary battery cells as well as methods of determining whether a cell exhibits improved resistance to thermal runaway. A method includes localizing a flame retardant material to a target site on a cell. A target site is optionally within a cell, external to a cell or both.

It was found that broad localization of flame retardant material as was done in prior publications was not optimally effective in preventing thermal runaway of a cell. Unexpectedly, it was found that localizing a flame retardant material to a target site on or within a cell showed far superior ability to prevent thermal runaway. The step of localizing is optionally exclusive of non-target site(s) on a cell. As such, in some aspects, a target site alone is used for localizing a flame retardant material and other locations are optionally not coated with the same flame retardant material. A target site optionally covers less than 50% the surface area of a cell, optionally less than 40%, optionally less than 30%, optionally less than 20%, optionally less than 10%.

A target site optionally is internal to a cell or portion thereof or external to a cell or a portion thereof. In some aspects, more than one target site is present with the exception that the area of all target sites is optionally less than 50% the surface area of the cell, optionally less than 40%, optionally less than 30%, optionally less than 20%, optionally less than 10% the surface area of the cell.

A target site is optionally an area that experiences a temperature of 100° C. or greater upon overcharge, optionally 200° C. or greater, optionally 300° C. or greater, optionally 400° C. or greater. A target site is optionally in contact with or on an area exposed to vapor produced by the cell such as from the electrolyte or other material used in the cell, upon cell temperature reaching a temperature of 100° C. or greater. A target site is optionally proximate to, including or surrounding a pressure relief feature. A pressure relief feature is optionally any region of a cell that vapor produced from an electrolyte or other chemical within a cell may penetrate to the exterior environment. Illustrative examples of a pressure relief feature include vent plug(s), hermetic seal area(s), and weld seam(s). A target site is optionally intermediate of one or more tabs and one or more electrodes. A target site is optionally a surface surrounding a pressure relief feature, optionally including the surface of the pressure relief feature itself. A target site is optionally spatially above a pressure relief feature such as in a configuration where the flame retardant is layered in a screen or other support surface that may be suspendable or otherwise located in a position vertically above a pressure relief feature during testing or normal operation of the cell. Combinations of such target sites are optionally used.

A target site is on, directly on, suspended above, or combinations thereof, a cell. A cell is optionally any cell type that is capable of thermal runaway. Illustrative examples of a cell include a prismatic cell, button cell, pouch cell, or a cylindrical cell. Such cells are commercially available, illustratively from Johnson Controls, Glendale, Wis.

A flame retardant is in some aspects a material that is non-flammable under conditions of combustion of a cell, such as a lithium ion cell, in a condition of thermal runaway. In some aspects, a flame retardant optionally is thermally decomposable at a temperature of less than 900° C., optionally less than 800° C., optionally less than 700° C., optionally less than 600° C., optionally less than 500° C., optionally less than 400° C., optionally less than 300° C., optionally less than 200° C. A thermally decomposable flame retardant is one that is defined to create a halon-type gaseous species upon exposure to the decomposition temperature where the gaseous species is functional to abate combustion. A halon-type gaseous species is a generally lower molecular weight, halogen(s)-bearing organic molecule optionally having a monomer of 500 Da or less. A flame retardant species is optionally a halogen containing species, optionally a fluorine containing species.

The amount of the flame retardant (FR) materials is governed by two criteria: how much material is needed to assure >6 vol % of the FR mixes with the vented electrolyte, and how much material is needed to absorb and dissipate enough heat to stop thermal run-away propagation to a neighboring cell. In some aspects, the FR is present at a weight ratio relative to the weight of a cell upon which it is applied to a target area. Optionally, the amount of FR is present at a ratio of 6% wt/wt of FR to cell weight. Optionally, the weight percent amount of FR relative to cell weight is 6, 7, 8, 9, 10, 12, 15, 20, 25, 30, 35%, optionally or more. Optionally, the weight percent amount of FR relative to cell weight is 10% to 50%, optionally 10% to 30%. Optionally, the weight percent amount of FR relative to cell weight is 50% or less, optionally 40% or less, optionally 30% or less, optionally 20% or less, where the lower limit is optionally 6% by weight.

Illustrative examples of a flame retardant include halogenated phosphazenes, perfluorocarbons, halogenated (optionally to 60% or greater) alkanes, ethers, ketones, or amines. Illustrative examples of an ether include methoxyheptafluoropropane, methoxynonafluorobutane, ethoxynonaflurobutane, fluoropolyethers, perfluoropolyethers, among others. Illustrative examples of flame retardants are illustrated in WO 2009/108374, U.S. 2010/0136404, and U.S. 2014/0065461.

In some aspects, a flame retardant is or includes one or more fluoropolyethers, optionally perfluoropolyethers, such as those described by Kasai in J. Appl. Polymer Sci. 57, 797 (1995) and they are commercially available as certain KRYTOX® and FOMBLIN® products. A fluoropolyether is defined as a polymeric chain structure with an oxygen in the backbone separated by fluorocarbons groups having between 1 to 3 carbons. A fluoropolyether optionally includes a carboxyl group on one or both ends of the molecule where the carbon of the carboxyl group may be bound to a non-fluorine atom such as a hydrogen. In illustrative examples of fluoropolyethers, the materials optionally include ether oxygens in the number of 2, 3, 4, 5, 6, or more. In some aspects, a fluoropolyether includes at least 9 carbon atoms, optionally in groups of 2 or 3 carbons separated by an oxygen in an ether linkage.

In some aspects, a flame retardant is in the form of a semi-solid meaning that the semi-solid state is such that the material does not flow due to gravitational forces alone, but remains where it is positioned at or on a target site for the expected lifetime of the battery under ambient conditions as described herein and is capable of being shaped or spread by hand force. A material is a semi-solid under conditions of normal battery operation, optionally a semi-solid at ambient conditions of temperature and pressure of 15° C. to 40° C. and 1 atmosphere, respectively. As such, a semi-solid is appreciated as neither a gas nor a liquid under the conditions of normal battery operation or ambient conditions as above. A semi-solid state facilitates positioning of the flame retardant material on a target site, preferably by coating a target site or above a target site, by not being flowable by the action of gravity alone at the application conditions. This contrasts to a liquid state that will assume the shape of its container by flowing, or a solid state that is not spreadable by hand force. Exemplary consistency of a semi-solid material is that of a wax, dough, grease, or putty. A semi-solid state may be that with a tensile strength of zero due to the inability to form a suitable structure with sufficient integrity for such testing such as testing by ASTM D638.

Optionally, a semi-solid material includes one or more fluoropolyethers, optionally perfluoropolyethers in such a configuration that the material is a liquid is mixed with a fluoropolyether or perfluoropolyether in the form of a solid so that the resulting material forms a semi-solid as used herein. As such, optionally a flame retardant includes a fluoropolyether mixture where a component of the semi-solid mixture has a sufficiently low molecular weight to form a liquid that when mixed with a fluoropolyether that has a sufficient chemical structure to form a solid that a semi-solid material is formed. Illustrative examples of such materials can be found in U.S. Patent Application Publication No: 2014/0065461.

A semi-solid material is optionally formed by mixing a liquid material with a solid material by any suitable means such as by hand mixing or mechanical mixing. The mixture is complete when no solid state is observed and no liquid state is observed, but a homogeneous semi-solid mixture is obtained.

A step of localizing is optionally by the use of hand application or use of a tool such as a trowel, brush, or other application tool suitable for applying and working a semi-solid material. Once applied, the semi-solid material does not spontaneously flow away under ambient conditions as defined herein for the expected lifetime of the battery under normal operating conditions.

A flame retardant optionally is a thermal conductor or thermal absorber alone or in conjunction with thermal decomposition to form a halon-type species. As such, flame retardants are optionally bi-functional.

Also provided are processes of measuring thermal runaway in a secondary cell including localizing a thermally decomposable flame retardant to a target site of a secondary cell where the localizing is optionally exclusive of non-target site regions. A process optionally includes elevating the temperature of the cell or a component thereof, optionally the electrolyte. The temperature is optionally elevated to a temperature that will produce gaseous electrolyte or electrode compounds. The temperature is optionally elevated by creating an overcharge condition, by heating the cell, or other method. The process includes activating an ignition source to ignite the vapor creating the initial conditions of thermal runaway.

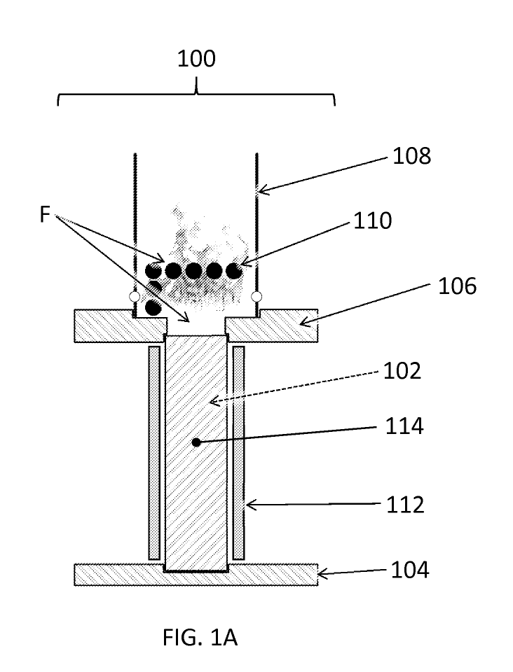

Also provided are test apparatuses suitable for instigating thermal runaway in a secondary battery and determining the effectiveness of methods of preventing or controlling thermal runaway in a secondary battery. An exemplary apparatus is depicted in FIG. 1 illustrating the apparatus 100 with a secondary cylindrical cell 102 positioned within the apparatus. It is appreciated that while in use, the apparatus will include the cell, but the apparatus as provided need not include the cell as an essential component of the apparatus. An apparatus 100 optionally includes a base 104. A base 104 when present is physically associated with a top plate 106. A top plate includes a passage that is suitably sized to allow venting of gas from a cell into the atmosphere above a cell when present. In some aspects, a passage is suitably sized to physically hold the battery in position for proper placement during testing. A top plate passage is appreciated to be localized to a position above a base 104 such that a battery, when present, may be held in a substantially vertical orientation relative to the base, top plate, or both. A base 104 and a top plate 106 are optionally planar in configuration, but may have any suitable outer shape such as square, rectangular, polygonal, circular, ellipsoidal, or other desired shape. A base, top plate, or both are optionally made of any desired material, optionally a flame retardant or resistant material. Illustrative examples of a material include, but are not limited to, metals (e.g. aluminum, steel, tin), polymeric materials (e.g. polycarbonate, polyethylene terephthalate, urethanes), or other desired material. The top plate 106 and base 104 are optionally directly connected by one or more supports. A support is optionally in the form of a rod or other shape suitable for physically associating the base and top plate in a vertical configuration. A support optionally is or includes a threaded section whereby a top plate may be fixedly associated to a bottom plate with sufficient force to restrain a cell placed between the base and the top plate.

An apparatus 100, includes a chimney 108 that is on, optionally directly on a top plate 106. A chimney is optionally a cylindrical, square, oval, rectangular, polygonal or other desired outer shape that forms a cavity with an interior that is suitably sized to fit over a passage in a top plate. A chimney is optionally formed of a cylindrical shape. A chimney is optionally formed of a steel (e.g. stainless steel, galvanized steel), aluminum, polymeric material, or other material that is able to structurally withstand the heat generated during a thermal runaway condition of a cell placed proximate and below the chimney. A top plate 106 optionally includes a groove suitable for sitting a chimney 108 onto the top plate. A groove is any suitable depth to prevent the chimney from moving along the surface of the top plate during operation of the apparatus. A groove is optionally from 0.1 mm to 10 mm, or any value or range therebetween.

An apparatus 100 optionally includes a screen 110 that is positioned within the chimney. A screen 110 is optionally oriented in a suspended configuration over the top of a cell and is capable of holding a flame retardant material within the screen in a position that is over the upper surface of the cell. The screen 110 is optionally positioned at least partially on a top plate 106, physically associated with the chimney 108, or combinations thereof. Any screen material that is capable of withstanding the heat of thermal runaway may be used, in some aspects. A screen 110 is optionally made from a steel, aluminum, or other suitable material.

In some aspects, a cell is wrapped in an insulation material 112 that will optionally entirely surround the cell in a vertical orientation with the proviso that an insulation material 112 is not positioned on the top most surface of the cell. In FIG. 1, the insulation 112 is shown in cross section where the cell is wrapped by a single layer of the insulation. In some aspects, insulation is made from a polyimide material, or other material suitable for insulating a battery. Insulation is optionally held in place by a clamp, adhesive, binding, or other suitable device.

An apparatus 100, optionally includes a thermocouple 114 that is on the surface of a cell so that the cell temperature can be monitored during operation. A thermocouple is optionally on or directly on the surface of the cell, located within the chimney, or other location in the apparatus, or combinations thereof. A thermocouple, is any art recognized thermocouple suitable for measuring temperature of a cell during thermal runaway.

In some aspects, an apparatus optionally includes a glow plug, or other suitable device for igniting a flammable gas within or above the chimney. In operation, when a sufficient overcharge is achieved to raise the temperature of the cell above a desired point, the glow plug is activated to ignite the electrolyte vapor further supporting thermal runaway.

In operation, an apparatus may be used to test the efficacy of one or more flame retardants when the flame retardant is localized to a target site on or near a cell. In the exemplary aspect illustrated in FIG. 1, a flame retardant (denoted as F) is optionally coated onto, or surrounding a screen located above a pressure relief feature in a cell. Flame retardant is optionally localized to a target site on the surface of the cell that includes a pressure relief feature. In some aspects, a flame retardant is localized surrounding a pressure relief feature, but does not extend beyond the pressure relief feature or surface including the pressure relief feature, and optionally is coated on a screen or other surface above a pressure relief feature. Such configurations surprisingly demonstrate excellent ability to prevent thermal runaway in a cell as illustrated herein.

In some aspects, an apparatus is housed in a protective chamber to insulate the apparatus from the environment. An illustrative example of a protective chamber is depicted in FIG. 1B with numbering reserved between FIGS. 1A and B. The protective chamber includes an outer structure 116 such as a steel barrel. An exemplary outer structure 116 is a 30 gallon steel barrel. An inner structure 118, optionally a steel barrel of lower volume than the outer structure, optionally 16 gallons, is housed inside the outer structure. The space between the outer structure 116 and the inner structure 118 is optionally filed with an insulating later 120. Any suitable insulating material may be used, illustratively, loose fill mineral wool insulation. FIG. 1B also illustrates the positioning of a glow plug 122 as localized above the test apparatus 100.

### EXAMPLES

### Example 1

A test apparatus set up substantially as depicted in FIG. 1 is placed into a steel container. The steel container is insulated on the outside with loose fill mineral wool insulation and placed into a 55 gallon steel drum. A plurality of JCI 6 Ah VL6P NCA chemistry high power cylindrical cells are subjected to testing under individual conditions one at a time in the test apparatus. The cell is equilibrated to ambient temperature (optionally 25° C.), and an Omega Engineering SA1 self-adhesive thermocouple (SA1-T-SC) is attached to the center of the outer surface of the cell. Current-carrying leads are electrically attached to the cell terminals. The cell is wrapped in a polyimide insulation and secured with a worm drive hose clamp or similar device. The cell is associated between a top plate and a bottom plate and held in place by a force normal to the length of the cell cylinder. The cell is oriented such that the safety vent (vent plug) is positioned within a passage in the top plate and the cell terminals are on the opposing face (bottom). The fixtured cell, chimney, screen, bolts, etc, are loaded onto a scale and the scale is tared.

A flame retardant (FR) is applied in the desired amounts to the reservoir depression above cell vent, to the screen, chimney walls, etc. The FRs used were either KBF01B (FRB), KBF01A (FRA), KBF01F (FRF), or combinations thereof and each were obtained from EI DU PONT DE NEMOURS AND COMPANY, Wilmington, Del. The screen is loaded into the groove in the top plate so to be localized above the upper surface of the cell and the vent plug. A steel chimney is attached to the top plate with bolts to hold the chimney in place. The completed apparatus is once again loaded onto the scale so that the weight difference is equivalent to the amount of flame retardant applied to the system. The entire apparatus including the cell is loaded into an ARC and the appropriate electrical connections are made to the cell, the thermocouples, and the glow plug. Thermocouples are attached to the cell skin surface, the wall of the barrel in which the test apparatus is placed, and in the air within the barrel. The glow plug is positioned centered approximately 2 inches above the top of the steel chimney. A data logger is used to record temperature and current at 10 second intervals.

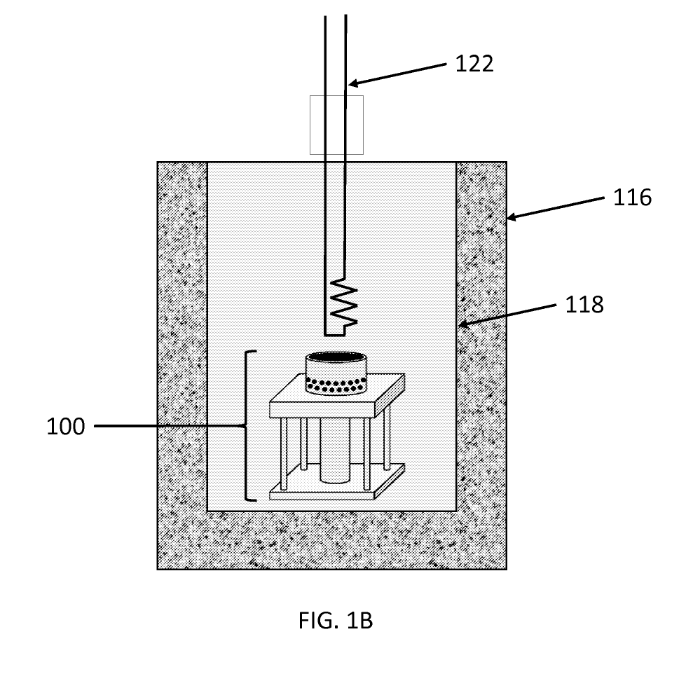

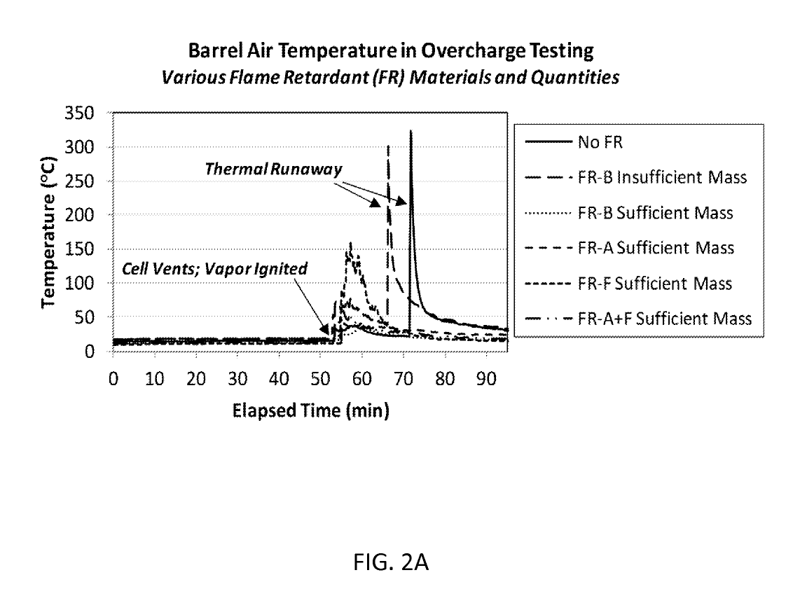

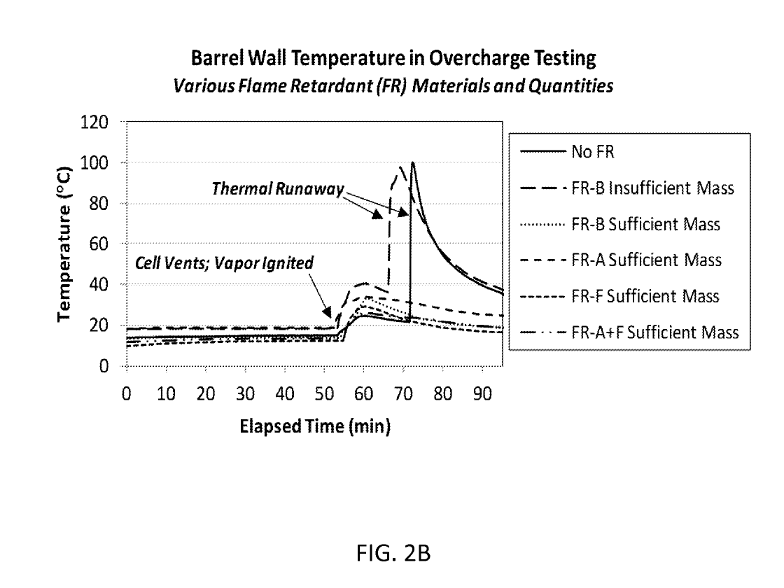

Cells are overcharged to approximately 4.9V (225% SOC) and vented, at which point cell skin temperature rises to 110° C. The cell's vent is also a CID, and activation of the vent stops overcharge current flow. At the point of stoppage of the overcharge current, the vented electrolyte vapor is ignited by the glow plug, and burns with a sustained flame for 15-20 min. During this time the cell's temperature continues to rise—the cell's vent cap is in contact with the flame and transmits heat back into the cell body. With insufficient (or an absence of) FR, the cell skin temperature slowly rises to 160° C., at which point rapid thermal runaway is triggered. The skin temperature of cells tested with sufficient FR grease applied to the test setup rise to 120-140° C., but after 15-20 minutes the electrolyte vapor fire ceases and the cell begins to cool. Test results of cell tests from temperatures recorded at 10 second intervals at the three thermocouple positions are depicted in FIGS. 2A-C. Detailed results are illustrated in Table 1.

TABLE 1
Overcharge: Beginning from ~50% SOC, cells were overcharged at 12 A (2C) until failure (cells vent at ~225% SOC)

| | | Quantity | | | | | | | |
|---|---|---|---|---|---|---|---|---|---|
| | | of FR | | | | | | | |
| | | Material | | Time | | Starting Cell | Max Cell | Max Barrel | Max Barrel |
| Exp. | FR Material | (g) | Event | (min) | Result | Skin T (° C.) | Skin T (° C.) | Wall T (° C.) | Air T (° C.) |
| 1 | None | 0 | 1 | 53 | Cell vented and vapor was ignited | 21 | 324 | 100 | 321 |
| | | | 2 | 60 | Fire burns out; cell continues self heating | | | | |
| | | | 3 | 72 | ▴Thermal runaway event | | | | |
| 7 | None | 0 | 1 | 56 | Cell vented and vapor was ignited | 20 | 395 | 70 | 248 |
| | | | 3 | 76 | ▴Thermal runaway event | | | | |
| 2 | KBF01B | 16 | 1 | 54 | Cell vented and vapor was ignited | 21 | 329 | 97 | 296 |
| | | | 2 | 79 | ▴Thermal runaway event | | | | |
| 6 | KBF01B | 63 | 1 | 54 | Cell vented and vapor was ignited | 22 | 144 | 34 | 39 |
| | | | 2 | 67 | Fire burns out | | | | |
| 3 | KBF01A | 69 | 1 | 53 | Cell vented and vapor was ignited | 22 | 131 | 34 | 53 |
| | | | 2 | 67 | Fire burns out | | | | |
| 4 | KBF01F | 72 | 1 | 55 | Cell vented and vapor was ignited | 18 | 135 | 29 | 159 |
| | | | 2 | 71 | Fire burns out | | | | |
| 5 | KBF01A + F | 60 (A + F) | 1 | 55 | Cell vented and vapor was ignited | 18 | 122 | 26 | 64 |
| | ~50:50 mix | | 2 | 76 | Fire burns out | | | | |

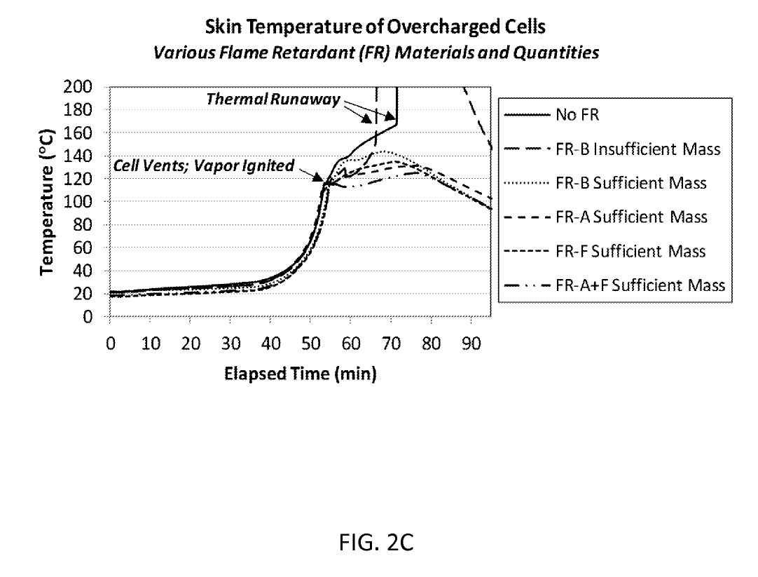

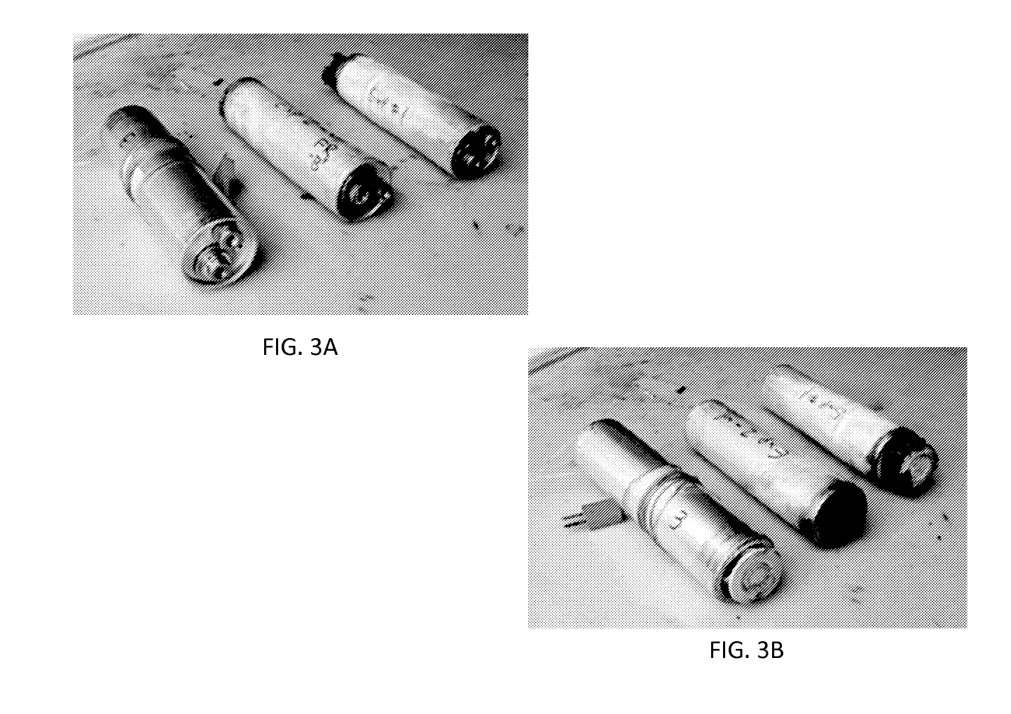

Photographs of cells that are either coated on the vent plug surface with a sufficient amount of FR material(s), cells coated with an insufficient amount of FR material, or tested in the absence of FR materials are illustrated in FIGS. 3A and B.

Overall, test setups containing FR materials localized at/near the cell vent experience the same initial effect of venting and ignition of vented vapor; but, with sufficient FR material present the cells do not reach 160° C., and the fire dies out after approx. 15-20 min. The cells then begin cooling instead of continuing to self-heat and thermally run away as do the untreated cells, or the cells treated with an insufficient amount of FR material. Following testing, vented cells that do not thermally run away due to the presence of a sufficient amount of FR material are recovered in otherwise good shape. Cells that are either treated with an insufficient amount of FR material or are untreated all thermally run away and are thereby damaged, charred, warped, and otherwise heat affected.

### Example 2

The testing process of Example 1 is repeated using an excess of 60 grams of semi-solid copolymer fluoroether formed of a mixture of tetrafluoroethylene/hexafluoropropylene copolymer (FEP) having a melt flow rate (MFR) of 30 g/10 min and hexafluoropropylene content of 10 wt %. The copolymer has a Mn exceeding 50,000 and a melting temperature of 255° C. and the consistency of putty. The copolymer is mixed in a 50:50 weight ratio with CF₃CF₂CF₂—O—(—CFCF₃—CF₂—O—)ₙ—CFCF₃—COON where n is an average of 14 and is a liquid at ambient temperatures and pressures. The semi-solid mixture is applied to the vent plug to such a depth that the entire vent plug is covered by the mixture, but areas surrounding the vent plug or other areas of the cell are absent any flame retardant material. The cells are subjected to conditions as per Example 1. Each cell tested is protected from thermal-runaway and survive the testing in good order.

Various modifications of the present invention, in addition to those shown and described herein, will be apparent to those skilled in the art of the above description. Such modifications are also intended to fall within the scope of the appended claims.

It is appreciated that all reagents are obtainable by sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof.

1. A process for preventing or containing a thermal runaway event in a battery cell comprising:
providing a secondary battery cell comprising a target site comprising a pressure relief feature; and
localizing an effective amount of a thermally decomposable flame retardant to said target site, said localizing exclusive of non-target site regions surrounding said target site or within said cell.

2. The process of claim 1 wherein said pressure relief feature comprises a vent plug.

3. The process of claim 1 or 2 wherein said target site is proximate to or surrounding an ignition source.

4. The process of claim 1 or 2 wherein said target site is intermediate to one or more tabs and one or more electrodes.

5. The process of claim 1 or 2 wherein said flame retardant is present at 6 percent to 50 percent by weight relative to said cell.

6. The process of claim 1 or 2 wherein said target site experiences a temperature of 100° C. or greater upon overcharge of greater than 200% the state of charge (SOC).

7. The process of any one of claim 1 or 2 wherein said cell is a prismatic cell, button cell, pouch cell, or a cylindrical cell.

8. The process of any one of claim 1 or 2 wherein said thermally decomposable flame retardant is capable of decomposing to form a gaseous halogen-bearing species upon reaching a temperature of 200° C. or greater.

9. The process of any one of claim 1 or 2 wherein said flame retardant is a heat conductor.

10. A process for measuring thermal runaway in a secondary cell comprising:
localizing a thermally decomposable flame retardant to a target site of a secondary battery cell, said localizing exclusive of non-target site regions surrounding or within said cell;
subjecting said cell to an overcharge condition; and
activating an ignition source to ignite electrolyte vapor produced by said overcharge condition.

11. The process of claim 10 wherein said flame retardant is localized to a screen or other porous surface suspended above said target area.

12. The process of claim 10 or 11 wherein said flame retardant is localized to a pressure relief feature on said cell.

13. The process of any one of claims 10-11 wherein said cell is overcharged to greater than 100% SOC.

14. The process of any one of claims 10-11 further comprising wrapping or otherwise containing said cell in a thermally insulating environment.

15. The process of any one of claims 10-11 wherein said cell is a prismatic cell, button cell, pouch cell, or a cylindrical cell.

16. An apparatus for testing thermal runaway in a battery, said apparatus comprising:
a base
a top plate comprising a passage, said top plate fixedly associated with said base by a plurality of supports, said top plate associated with said base with sufficient force to hold a battery therebetween under conditions of thermal runaway;
a screen suspended at least partially above said top plate above said passage; and
a chimney on said top plate above said passage.

17. The apparatus of claim 1 axially surrounded by an inner structure.

18. The apparatus of claim 17 wherein said inner structure is axially surrounded by an outer structure.

19. The apparatus of claim 18 wherein a space between said inner structure and said outer structure is filled with an insulating material.
